(19) United States
(12) Patent Application Publication
(10) Pub. No.: US 2026/0188052 A1
(43) Pub. Date: Jul. 2, 2026

(54) REFLEX-BASED GAZE REACTION VERIFICATION FOR ONLINE PROCTORING

(71) Applicants: Constructor Technology AG, Schaffhausen (CH); Constructor Education and Research Genossenschaft, Schaffhausen (CH)

(72) Inventors: Sergey Ulasen, Singapore (SG); Rasilia Rakhmatulina, Sofia (BG); Andrey Adashchik, Sofia (BG); Serg Bell, Singapore (SG); Stanislav Protasov, Singapore (SG); Nikolay Dobrovolskiy, Alanya (TR); Laurent Dedenis, Geneve (CH)

(21) Appl. No.: 19/543,932

(22) Filed: Feb. 19, 2026

Related U.S. Application Data
(63) Continuation-in-part of application No. 19/034,694, filed on Jan. 23, 2025.
(63) Continuation-in-part of application No. 19/004,064, filed on Dec. 27, 2024, now Pat. No. 12,531,002.

(51) Int. Cl. G06V 40/40; G06V 10/764; G06V 20/40; G06V 40/20; G09B 7/00

(52) U.S. Cl. CPC G06V 40/40; G06V 10/764; G06V 20/40; G06V 40/20; G09B 7/00

(57) ABSTRACT

Aspects of the present disclosure include a method comprising receiving a video stream of a user during an online session, initiating a calibration by providing for presentation on a display a calibration element positioned at a first position on the display, detecting a gaze direction and/or head rotation of the user based on the video stream, determining a mapping between the first position and the gaze direction and/or head rotation, initiating a verification check during the session by providing for presentation on the display a visual stimulus element randomly positioned at a second position on the display, determining a change in the gaze direction and/or head rotation during the verification check, and verifying whether the user is in front of the display by determining whether the user reacted to the visual stimulus element based on the mapping, the change, and the second position. The verification check occurs after the calibration.

### CROSS-REFERENCE TO RELATED APPLICATIONS

This application is a continuation-in-part of and claims the benefit of priority to both U.S. patent application Ser. No. 19/034,694, filed on Jan. 23, 2025 and entitled “PROCTORING OF ONLINE EXAMINATIONS USING GAZE DETERMINATION,” and U.S. patent application Ser. No. 19/004,064, filed on Dec. 27, 2024 and entitled “SYSTEMS AND METHODS FOR DETECTION OF THE PRESENCE OF A PERSON IN FRONT OF A DISPLAY WITH A CAMERA,” the contents of which are incorporated by reference herein in the entirety.

### FIELD OF TECHNOLOGY

The present disclosure relates to the field of online presence and liveness verification, and, more specifically, to systems and methods for verifying live user presence in an online session by detecting reflex-based gaze reaction.

### BACKGROUND

A deepfake is an artificial image or video.

Examinations are now commonly taken on computers, offering convenience and accessibility for both learners and institutions. These computer examinations are conducted through specialized software or platforms that allow learners to take tests from remote locations. They often include features like automated proctoring, time tracking, and instant grading. However, this shift to computer examinations has also introduced new opportunities for cheating. Learners might use unauthorized resources such as notes, search engines, or communication tools like messaging apps during the exam. Other learners may simply have someone else pretend to be the learner and take the computer examination for the learner under the learner's login credentials. In other cases, in examinations with video proctoring, a pre-recorded video loop or a deepfake of the candidate sitting still or pretending to take the exam could be played while the real exam is being taken by someone else. These methods exploit the weaknesses in online proctoring systems, especially in cases where human proctors or artificial intelligence (AI) may not be able to detect subtle signs of cheating. Therefore, there is a need to strengthen online presence and liveness verification during online sessions (e.g., remote exams or remote proctoring) against deepfakes, prerecorded video, and remote helpers

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

One aspect of the present disclosure includes a method for verifying live user presence in front of a display in an online session. The method comprises receiving a video data stream of a user during the online session, and initiating a calibration by providing for presentation on the display a calibration element. The calibration element is positioned at a first position on the display during the calibration. The method further comprises detecting at least one of a gaze direction or a head rotation of the user during the calibration based on the video data stream, determining a mapping between the first position and at least one of the gaze direction or the head rotation, and initiating a verification check during the online session by providing for presentation on the display a visual stimulus element. The verification check occurs after the calibration, and the visual stimulus element is randomly positioned at a second position on the display during the verification check. The method further comprises determining at least one change in at least one of the gaze direction or the head rotation during the verification check, and verifying whether the user is in front of the display by determining whether the user reacted to the visual stimulus element based on the mapping, the at least one change, and the second position.

Another aspect of the present disclosure includes a system for verifying live user presence in front of a display in an online session. The system comprises one or more memories configured to store executable instructions, and one or more processors communicatively coupled with the one or more memories. The one or more processors are configured, individually or in any combination, to execute the executable instructions to receive a video data stream of a user during the online session, and initiate a calibration by providing for presentation on the display a calibration element. The calibration element is positioned at a first position on the display during the calibration. The one or more processors are further configured, individually or in any combination, to execute the executable instructions to detect at least one of a gaze direction or a head rotation of the user during the calibration based on the video data stream, determine a mapping between the first position and at least one of the gaze direction or the head rotation, and initiate a verification check during the online session by providing for presentation on the display a visual stimulus element. The verification check occurs after the calibration, and the visual stimulus element is randomly positioned at a second position on the display during the verification check. The one or more processors are further configured, individually or in any combination, to execute the executable instructions to determine at least one change in at least one of the gaze direction or the head rotation during the verification check, and verify whether the user is in front of the display by determining whether the user reacted to the visual stimulus element based on the mapping, the at least one change, and the second position.

Another aspect of the present disclosure includes a non-transitory computer-readable medium having instructions for verifying live user presence in front of a display in an online session. The instructions are executable by one or more processors, individually or in any combination, to receive a video data stream of a user during the online session, and initiate a calibration by providing for presentation on the display a calibration element. The calibration element is positioned at a first position on the display during the calibration. The instructions are further executable by the one or more processors, individually or in any combination, to detect at least one of a gaze direction or a head rotation of the user during the calibration based on the video data stream, determine a mapping between the first position and at least one of the gaze direction or the head rotation, and initiate a verification check during the online session by providing for presentation on the display a visual stimulus element. The verification check occurs after the calibration, and the visual stimulus element is randomly positioned at a second position on the display during the verification check. The instructions are further executable by the one or more processors, individually or in any combination, to execute the executable instructions to determine at least one change in at least one of the gaze direction or the head rotation during the verification check, and verify whether the user is in front of the display by determining whether the user reacted to the visual stimulus element based on the mapping, the at least one change, and the second position.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram of an example environment for verifying live user presence in front of a display in an online session, according to some aspects of the present disclosure;

FIG. 2 is a block diagram of an example monitoring module, according to some aspects of the present disclosure;

FIG. 3 is a block diagram of an example visual stimulus generator module, according to some aspects of the present disclosure;

FIG. 4 is a block diagram of an example detection and correlation module, according to some aspects of the present disclosure;

FIG. 5 is a block diagram of an example decision and escalation module, according to some aspects of the present disclosure;

FIG. 6A is an example calibration during an online session, according to some aspects of the present disclosure;

FIG. 6B is an example current state of the same online session of FIG. 6A after the calibration, according to some aspects of the present disclosure;

FIG. 6C is an example visual stimulus element presented during the same online session of FIG. 6A, according to some aspects of the present disclosure;

FIG. 6D is another example visual stimulus element presented during the same online session of FIG. 6A, according to some aspects of the present disclosure;

FIG. 7 is flow diagram of an example method for verifying live user presence in front of a display in an online session, according to some aspects of the present disclosure; and

FIG. 8 presents an example of a general-purpose computer system on which aspects of the present disclosure can be implemented.

### DETAILED DESCRIPTION

Aspects of the disclosure improve online presence and liveness verification during online sessions (e.g., remote exams or remote proctoring) against deepfakes, prerecorded video, and remote helpers. Aspects of the disclosure utilize eye gaze tracking to verify that a user captured by a camera during an online session (e.g., an online examination) is the same user who is participating in and/or interacting with on-screen content presented during the online session, i.e., the user is actually sitting in front of, and visually attending to, a specific display during the online session. Specifically, after a calibration that maps an eye gaze and/or head rotation (i.e., head orientation) of the user to screen coordinates (i.e., screen positions) of the display, a verification check is initiated. The verification check includes presenting one or more visually salient interface elements at random screen coordinates (i.e., screen positions) on the display for short periods of time (e.g., few seconds) and at random moments during the online session. If the user is actually sitting in front of the display, the user will reflexively look at such elements. The verification check is successful if changes in eye gaze direction and/or head rotation (i.e., head orientation) of the user towards each position of each element on the display is detected within a pre-defined reaction time window. If the verification check is successful, the user is verified as a genuine user whose presence in front of the display is real. If the verification check fails, the online session with the user is flagged as potentially suspicious. For example, the online session can be flagged as a potential cheating attempt in which the user is a deepfake or a prerecorded video, and another person (e.g., a remote helper) is using a duplicated screen and/or operating a keyboard and/or a mouse to respond to the on-screen content presented during the online session. By providing a robust, hard to spoof liveness and user identity check during online sessions, aspects of the disclosure can increase the reliability of online exam proctoring and other similar online sessions.

Exemplary aspects are described herein in the context of a system, a method, and a non-transitory computer-readable medium for verifying live user presence in front of a display in an online session. Aspects of the present disclosure include receiving a video data stream of a user during the online session, initiating a calibration by providing for presentation on the display a calibration element, detecting at least one of a gaze direction or a head rotation of the user during the calibration based on the video data stream, determining a mapping between the first position and at least one of the gaze direction or the head rotation, initiating a verification check during the online session by providing for presentation on the display a visual stimulus element, determining at least one change in at least one of the gaze direction or the head rotation during the verification check, and verifying whether the user is in front of the display by determining whether the user reacted to the visual stimulus element based on the mapping, the at least one change, and the second position. The calibration element is positioned at a first position on the display during the calibration. The verification check occurs after the calibration, and the visual stimulus element is randomly positioned at a second position on the display during the verification check.

In one aspect, the determining whether the user reacted to the visual stimulus element comprises determining a third position on the display corresponding to the at least one change based on the mapping. In one aspect, the determining whether the user reacted to the visual stimulus element further comprises making a first determination of whether there is spatial correspondence between the second position and the third position based on a spatial threshold, and making a second determination of whether there is temporal alignment between the visual stimulus element and the at least one change based on a temporal threshold. In one aspect, the determining whether the user reacted to the visual stimulus element further comprises classifying, using a machine learning model, whether the user reacted to the visual event or failed to react to the visual event based on the first and second determinations. In one aspect, the determining whether the user reacted to the visual stimulus element further comprises determining a presence score of the user based on the classifying, where the presence score is indicative of a likelihood the user is in front of the display, and the user is verified to be in front of the display if the presence score exceeds a score threshold.

In one aspect, the video data stream is captured via a camera of a computing device including the display.

In one aspect, the online session comprises an online examination session, and the user is an examinee. In one aspect, examination content is provided for presentation on the display during the online examination session. In one aspect, at least one action is triggered in response to determining the user did not react to the visual stimulus element, where the at least one action comprises at least one of pausing the online examination session, terminating the online examination session, transmitting an alert to a proctor, initiating an additional verification check, or recording that the user did not react to the visual stimulus element.

In one aspect, the initiating the calibration further comprises instructing the user to look at and activate the calibration element at the first position on the display.

In one aspect, the initiating the verification check further comprises randomly selecting a time for the verification check, wherein the visual stimulus element is presented on the display at the randomly selected time.

In one aspect, the visual stimulus element comprises at least one of a bright visual object, a colored visual object, a flashing visual object, or a popup message or image.

In one aspect, the determining the at least one change in the at least one of the gaze direction or the head rotation during the verification check comprises determining, using at least one machine learning model, at least one of a baseline gaze direction or a baseline head rotation of the user based on one or more video frames of the video stream that were captured immediately before the verification check, and determining, using the at least one machine learning model, at least one of an updated gaze direction or an updated head rotation of the user based on one or more additional video frames of the video stream that were captured during the verification check.

Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

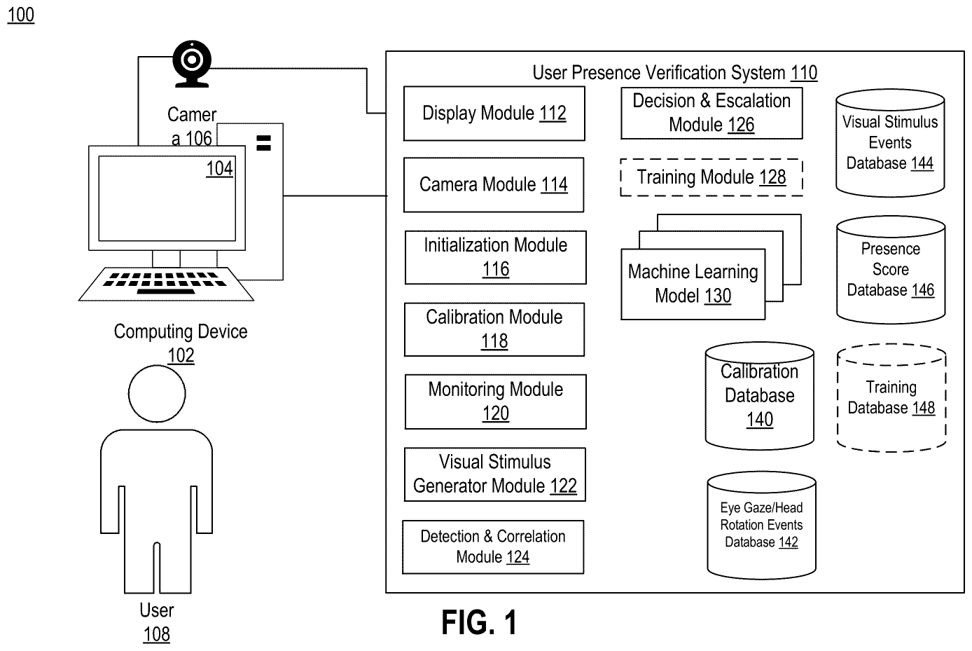

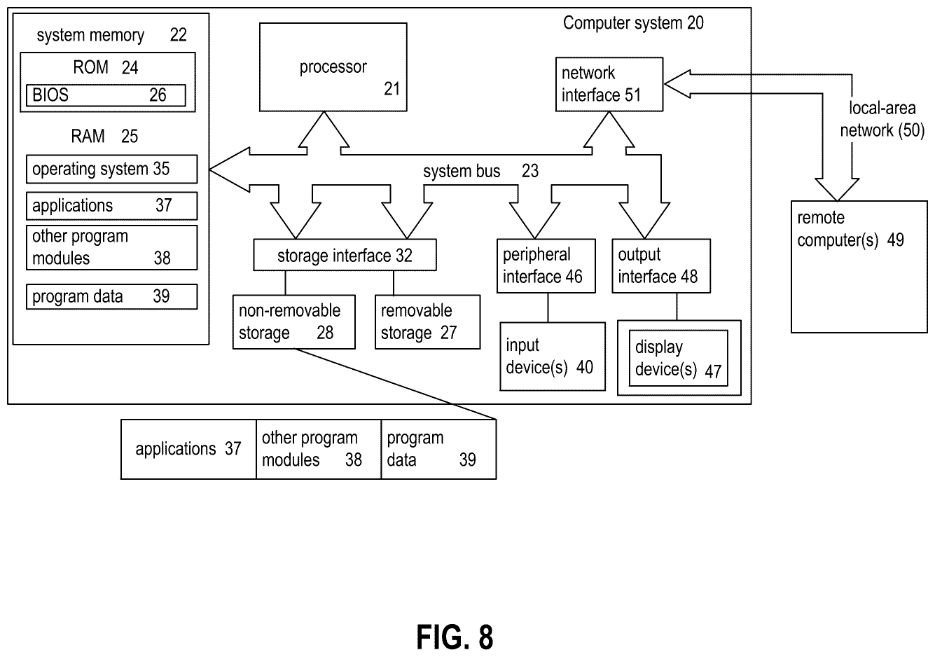

FIG. 1 is a block diagram of an example environment 100 for verifying live user presence in front of a display in an online session, according to some aspects of the present disclosure. In some aspects, the environment 100 includes a computing device 102. In some aspects, the computing device 102 in FIG. 1 is implemented as a computer system 20 in FIG. 8. Examples of a computing device 102 include, but are not limited to, a mobile phone, a smart phone, a laptop, a tablet computer, a personal digital assistant, a wearable device (e.g., a smart watch, a head-mounted display, smart glasses, etc.), a desktop computer, a gaming console, an Internet of Things (IoT) device, and/or other computerized devices.

In some aspects, the environment 100 includes a display 104 for displaying on-screen content. The display 104 is coupled to, or integrated in, the computing device 102. In one non-limiting example aspect, the display 104 is positioned in front of a user 108.

In some aspects, the computing device 102 executes a user presence verification system 110, which may be a standalone online presence and liveness verification software or a software component providing one or more online presence and liveness verification tools. The computing device 102 allows a user 108 to participate in an online session administered and/or proctored by the user presence verification system 110. As described in detail later herein, the user presence verification system 110 leverages advanced computer vision and/or machine learning techniques to detect a change in an eye gaze and/or a head rotation (i.e., head orientation) of the user 108 as a result of reflex (i.e., a rapid, involuntary, and automatic response to visual stimulus presented on the display 104), and, in turn, verify live presence of the user 108 during the online session.

In some aspects, the environment 100 includes a camera 106 for capturing a video data stream. In one aspect, the camera 106 is coupled to, or integrated in, the computing device 102. In another aspect, the camera 106 is coupled to the user presence verification system 110. The user presence verification system 110 can obtain one or more video data streams captured via the camera 106. In one non-limiting example aspect, the camera 106 is positioned in front of the user 108 and captures a video data stream of the user 108 during an online session administered and/or proctored by the user presence verification system 110.

In some aspects, the user presence verification system 110 includes a plurality of modules. In some aspects, the computing device 102 can execute at least one of the plurality of modules. In some aspects, the user presence verification system 110 can be implemented in the computing device 102 or a cloud network (not shown) that is configured to execute the plurality of modules that together make up the user presence verification system 110.

In some aspects, the user presence verification system 110 includes a display module 112 configured to generate one or more graphical user interfaces (GUIs), where each GUI includes content for presentation on the display 104 during an online session administered and/or proctored by the user presence verification system 110.

In some aspects, the user presence verification system 110 includes a camera module 114 configured for video acquisition. Specifically, the camera module 114 is configured to: (1) activate/trigger the camera 106 to capture a continuous video data stream of the user 108 during an online session administered and/or proctored by the user presence verification system 110, and (2) obtain the video data stream of the user 108.

In some aspects, the user presence verification system 110 includes an initialization module 116 configured to initialize an online session with the user 108. In one non-limiting example aspect, the online session comprises an online examination administered and/or proctored by the user presence verification system 110. In another non-limiting example aspect, the online session comprises an online course/program or other similar session (e.g., online training course/program, online certification course/program, online tutorial, etc.) administered by the user presence verification system 110.

In some aspects, the initialization module 116 is configured to invoke the camera module 114 which in turn activates/triggers the camera 106 to capture a continuous video data stream of the user 108 during the online session. In one aspect, the camera 106 is activated/triggered after the online session is initialized.

In some aspects, the initialization module 116 is configured to invoke the display module 112 to present on-screen content on the display 104 during the online session (e.g., examination content if the online session comprises an online examination).

In some aspects, the initialization module 116 is configured to monitor the progress (i.e., state) of the online session. In some aspects, a state of the online session is indicative of a progression of the online session (e.g., question index, current GUI presented on the display 104, etc.) and/or whether the online session is potentially suspicious (e.g., trust/suspicion score).

In some aspects, the user presence verification system 110 includes a calibration module 118 configured to receive a video data stream (e.g., from the camera module 114), and perform a calibration process (e.g., at the start of the online session) based on the video data stream received.

In some aspects, the calibration process includes calibrating at least one of an eye gaze direction or a head rotation (i.e., head orientation) of the user 108. In some aspects, as part of the calibration process, the calibration module 118 is configured to initiate a calibration by invoking the display module 112 to present one or more calibration elements on the display 104 during the calibration. Each calibration element comprises an interface element. Each calibration element has a corresponding known (i.e., pre-defined) screen position (e.g., screen coordinates) and/or screen region that the calibration element is positioned on the display 104.

In some aspects, as part of the calibration process, the calibration module 118 is configured to present an instruction to the user 108, where the instruction prompts the user 108 to look at, and optionally interact with, each calibration element presented. In some aspects, the one or more calibration elements and the instruction are presented simultaneously. In one aspect, the calibration module 118 invokes the display module 112 to present the instruction on the display 104. In another aspect, the calibration module 118 invokes another module (not shown) of the user presence verification system 110 to activate/trigger audio playback of the instruction, i.e., the instruction is presented via one or more audio speakers (not shown).

In some aspects, the user 108 can interact with a calibration element presented by clicking on the element (e.g., via a mouse, keyboard, or other input/output device) and/or touching the element (e.g., if the display 104 comprises a touch screen interface).

In some aspects, as part of the calibration process, the calibration module 118 is configured to utilize one or more machine learning models 130 to: (1) detect one or more facial landmarks (e.g., eyes, head) of the user 108 during the calibration, based on one or more video frames of the video data stream, and (2) estimate at least one of an eye gaze direction or a head rotation (i.e., head orientation) of the user 108 during the calibration. Specifically, the one or more video frames capture the user 108 while the user 108 is looking directly at each calibration element presented. In some aspects, the calibration module 118 estimates, for each calibration element presented, at least one of the following vectors: (1) a corresponding eye gaze direction vector representing an eye gaze direction the user 108 while the user 108 is looking directly at the calibration element, or (2) a corresponding head rotation vector representing a head rotation (i.e., head orientation) of the user 108 while the user 108 is looking directly at the calibration element.

In some aspects, as part of the calibration process, the calibration module 118 is configured to compute, for each calibration element presented, at least one of the following mappings: (1) a mapping between a corresponding known screen position/region that the calibration element is positioned on the display 104 and a corresponding eye gaze direction vector, or (2) a mapping between the known screen position/region and a corresponding head rotation vector.

In some aspects, as part of the calibration process, the calibration module 118 is configured to store calibration data relating to the user 108 for later use during the online session, such as use by one or more others modules of the user presence verification system 110. In some aspects, calibration data for the user 108 is stored in a database 140 (e.g., calibration database). In some aspects, as part of the calibration process, the calibration module 118 is configured to provide, as output, calibration data relating to the user 108 to one or more others modules of the user presence verification system 110.

In some aspects, calibration data for the user 108 comprises, but is not limited to, at least one of the following: one or more estimated eye gaze direction vectors, one or more estimated head rotation vectors, one or more known screen positions/regions corresponding to one or more calibration elements presented, one or more mappings between the one or more known screen positions/regions and the one of the one or more estimated eye gaze direction vectors, or one or more mappings between the one or more known screen positions/regions and the one or more estimated head rotation vectors.

In some aspects, the user presence verification system 110 includes a monitoring module 120 configured to receive at least one of the following inputs: calibration data relating to the user 108 (e.g., from calibration module 118); a video data stream (e.g., from camera module 114); or a current state of the online session (e.g., from the initialization module 116). In some aspects, the current state of the online session comprises current on-screen content presented on the display 104, such as a current GUI (e.g., a current online examination interface if the online session comprises an online examination).

In some aspects, the monitoring module 120 is configured to continuously monitor at least one of an eye gaze direction or a head rotation of the user 108 during the online session. Specifically, the monitoring module 120 utilizes at least one machine learning model 130 to estimate at least one of a current eye gaze direction or a current head rotation of the user 108 based on a subset of video frames of the video data stream. The subset includes one or more video frames capturing the user 108 while the current on-screen content (e.g., current GUI) is presented on the display 104. The monitoring module 120 determines, based on the calibration data relating to the user 108 and at least one of the current eye gaze direction or the current head rotation, a corresponding screen position/region on the display 104 that the user 108 is currently looking directly at.

In some aspects, the monitoring module 120 is configured to optionally check that the current eye gaze direction remains within a pre-defined screen area of the display 104, i.e., the current eye gaze direction is not persistently to a side of the display 104.

In some aspects, the monitoring module 120 is configured to provide, as output, a sequence of time-stamped events relating to the user 108 to one or more others modules of the user presence verification system 110. In some aspects, a sequence of time-stamped events relating to the user 108 represents a history of at least one of eye gazes or head rotations of the user 108 during the online session. Specifically, each time-stamped event of the sequence corresponds to a particular time during the online session, and the time-stamped event includes event information identifying: (1) at least one of an estimated eye gaze direction or an estimated head rotation of the user 108 at that particular time, and (2) a corresponding screen position/region on the display 104 the user 108 is looking directly at, at that particular time. In some aspects, the monitoring module 120 is configured to store a sequence of time-stamped events relating to the user 108 for later use during the online session, such as use by one or more others modules of the user presence verification system 110. In some aspects, a sequence of time-stamped events relating to the user 108 is stored in a database 142 (e.g., eye gaze/head rotation events database).

In some aspects, the user presence verification system 110 includes a visual stimulus generator module 122 configured to receive at least one of the following inputs: a current state of the online session (e.g., from initialization module 116); or a sequence of time-stamped events relating to the user 108 (e.g., from monitoring module 120). In some aspects, the current state of the online session comprises current on-screen content presented on the display 104, such as a current GUI (e.g., a current online examination interface if the online session comprises an online examination).

In some aspects, the visual stimulus generator module 122 is configured to initiate, at a random time or when a suspicious condition is met (e.g., trust/suspicion score falls below a predefined threshold), a verification check during the online session. As part of the verification check, the visual stimulus generator module 122 is configured to: (1) randomly select a screen position/region on the display 104, (2) generate a visual stimulus element, and (3) invoke the display module 112 to present the visual stimulus element on the display 104 at the screen position/region and for a short pre-defined period of time. In some aspects, the screen position/region is randomly selected from one of a plurality of corners or a plurality of interface zones of the display 104. For example, if the display 104 has four corners, the screen position/region can be within one of the four corners. As another example, if the display 104 is divided into a plurality of interface zones, the screen position/region can be within one of the zones.

In some aspects, the visual stimulus element presented is short-lived, i.e., the predefined period of time during which the visual stimulus element is presented can range from hundreds of milliseconds to a few seconds only.

In some aspects, multiple visual stimulus elements are generated and presented during the verification check, one after another. Each visual stimulus element comprises an interface element that is visually salient (i.e., triggers a reflex of the user 108). Examples of a visual stimulus element include, but are not limited to, a bright visual object (e.g., a bright patch), a colored visual object (e.g., a colored patch), a flashing visual object (e.g., a flashing icon), a popup message or image, etc. Each visual stimulus element represents a visual stimulus event.

In some aspects, the visual stimulus generator module 122 is configured to record, for each visual stimulus element presented, a corresponding start time representing when the visual stimulus element is first presented, a corresponding end time representing when the visual stimulus element is last presented, and a corresponding screen position/region on the display 104 the visual stimulus element is positioned at.

In some aspects, the visual stimulus generator module 122 is configured to provide, as output, a visual stimulus events log relating to the user 108 to one or more others modules of the user presence verification system 110. A visual stimulus events log comprises event information relating to one or more visual stimulus elements presented to the user 108 during a verification check, such as, but not limited to, one or more start times, one or more end times, and/or one or more screen positions/regions corresponding to the one or more visual stimulus elements. In some aspects, a visual stimulus events log is stored in a database 144 (e.g., visual stimulus events database).

In some aspects, the user presence verification system 110 includes a detection and correlation module 124 configured to receive at least one of the following inputs: a visual stimulus events log (e.g., from visual stimulus generator module 122); a sequence of time-stamped events relating to the user 108 (e.g., from monitoring module 120); calibration data relating to the user 108 (e.g., from calibration module 118); or a video data stream (e.g., from camera module 114).

In some aspects, the detection and correlation module 124 is configured to detect at least one change in at least one of an eye gaze direction or a head rotation of the user 108 during a verification check, based on at least one of the inputs received. In some aspects, for each visual stimulus element presented during the verification check (as determined from the visual stimulus events log), the module 124 selects one or more video frames of the video data stream that occur within a reaction time window corresponding to the visual stimulus element. The corresponding reaction time window occurs after a start time corresponding to the visual stimulus element. For example, the corresponding reaction time window can begin at the start time plus a pre-defined minimum reaction latency, and can end at the start time plus a pre-defined maximum reaction latency.

In some aspects, for one or more video frames of the video data stream that immediately precede a start time corresponding to a visual stimulus element, the module 124 determines: (1) at least one of a baseline eye gaze direction or a baseline head rotation of the user 108 before the visual stimulus element is presented, and (2) a baseline screen position/region on the display 104 corresponding to the baseline eye direction and/or the baseline head rotation.

In some aspects, for one or more selected video frames within a reaction time window corresponding to a visual stimulus element presented, the module 124 determines: (1) at least one of an updated eye gaze direction or an updated head rotation of the user 108 during the corresponding reaction time window, and (2) an updated screen position/region on the display 104 corresponding to the updated eye gaze direction and/or the updated head rotation.

In some aspects, the module 124 computes, for each visual stimulus element presented, at least one of the following changes: (1) a change between a baseline eye gaze direction of the user before the visual stimulus element is presented and an updated eye gaze direction during a corresponding reaction time window (i.e., eye gaze direction change), or (2) a change between a baseline head rotation of the user before the visual stimulus element is presented and an updated head rotation during the corresponding reaction time window (i.e., head rotation change). A reaction result for the visual stimulus element comprises at least one of the eye gaze direction change or the head rotation change.

In some aspects, for each visual stimulus element presented, the module 124 determines whether a spatial condition is met based on a reaction result corresponding to the visual stimulus element. Specifically, the module 124 checks if an updated screen position/region substantially matches a screen position/region corresponding to the visual stimulus element within a pre-defined spatial threshold, where the updated screen position/region corresponds to an updated eye gaze direction and/or an updated head rotation during a corresponding reaction time window. The spatial condition is met if the updated screen position/region substantially matches the screen position/region corresponding to the visual stimulus element within the pre-defined spatial threshold, i.e., there is spatial correspondence. In one aspect, the pre-defined spatial threshold is an angular or pixel distance.

In some aspects, for each visual stimulus element presented, the module 124 determines whether a temporal condition is met based on a reaction result corresponding to the visual stimulus element. Specifically, the module 124 checks if the corresponding reaction result (i.e., eye gaze direction change and/or head rotation change) occurs within a pre-defined temporal threshold. The temporal condition is met if the corresponding reaction result occurs within the predefined temporal threshold, i.e., there is temporal alignment. In one aspect, the pre-defined temporal threshold is between the pre-defined minimum reaction latency and the pre-defined maximum reaction latency.

In some aspects, the module 124 utilizes one or more machine learning models 130 to classify, for each visual stimulus element presented, a corresponding reaction result with a classification indicative of whether the reaction result is a valid reaction (i.e., a pass/success classification) or a failure to react (i.e., a fail classification). Specifically, the corresponding reaction result is classified with a success classification if both the spatial condition and the temporal condition are met. The corresponding reaction result is classified with a fail classification instead if at least one the spatial condition or the temporal condition is not met.

In some aspects, for each visual stimulus element presented, the module 124 outputs a classification for a corresponding reaction result and, optionally, a confidence score for the classification.

In some aspects, the user presence verification system 110 includes a decision and escalation module 126 configured to receive at least one of the following inputs: one or more classifications for one or more reaction results for one or more visual stimulus elements presented during a verification check during the online session(e.g., from detection and correlation module 124); optionally, one or more confidence scores for the one or more classifications; or, optionally, one or more additional inputs (e.g. reflection-based detection, keystroke behavior, etc.) from one or more others modules of the user presence verification system 110 and/or from an external system (e.g., proctoring system).

In some aspects, the module 126 is configured to maintain a presence score corresponding to the user 108, where the presence score indicates of a degree of likelihood the user 108 is in front of the display 104 during the online session. In some aspects, the presence score can be stored in a database 146 (e.g., presence score database).

In some aspects, the module 126 is configured to increase a presence score corresponding to the user 108 if classifications for reaction results corresponding to a pre-defined number of consecutive visual stimulus elements presented are pass/success classifications.

In some aspects, the module 126 is configured to decrease a presence score corresponding to the user 108 and/or flag the online session with the user 108 as potentially suspicious if a classification for a reaction result corresponding to a visual stimulus element presented is a fail classification.

In some aspects, the module 126 is configured to compare a presence score corresponding to the user 108 against one or more pre-defined thresholds. In some aspects, if the presence score exceeds a first pre-defined threshold, the module 126 determines that the user 108 successfully completed the verification check, and continues the online session (e.g., resumes presentation of on-screen content on the display 104, such as examination content).

In some aspects, if the presence score falls below the first pre-defined threshold, the module 126 triggers one or more additional verification checks (e.g., by invoking the visual stimulus generator module 122) and/or escalates to a human proctor for manual review (e.g., generate and transmit an optional alert to the human proctor).

In some aspects, if the presence score falls below a second pre-defined threshold, the module 126 is configured to perform at least one of the following actions: pause, terminate, or invalidate the online session (e.g., pause, terminate, or invalidate the online examination); generate an incident record for later review; or trigger one or more other online presence and liveness verification processes (e.g., reflection-based liveness checks).

In some aspects, the module 126 is configured to output, based on a presence score corresponding to the user 108, a decision indicative of whether the user 108 is in front of, and attending to the display 104 during the online session.

In some aspects, the user presence verification system 110 optionally includes a training module 128 and a training database 148 including one or more sets of training data. The training module 128 is configured to train or update (e.g., finetune) at least one machine learning model 130 based on at least one set of training data from the training database 148.

In some aspects, the user presence verification system 110 is configured to run on a standard end user device or consumer device, such as the computing device 102. In some aspects, the user presence verification system 110 is compatible with both web-based and native application environments. In some aspects, the user presence verification system 110 requires no specialized hardware components or resources, and can utilize standard hardware resources (e.g., a central processing unit (CPU), a graphical processing unit (GPU), and/or a memory) already available in standard end user devices or consumer devices. In some aspects, the user presence verification system 110 can be deployed on cloud servers for enterprise-scale application scenarios.

In some aspects, the user presence verification system 110 is integrated into, or implemented as part of, educational and training platforms.

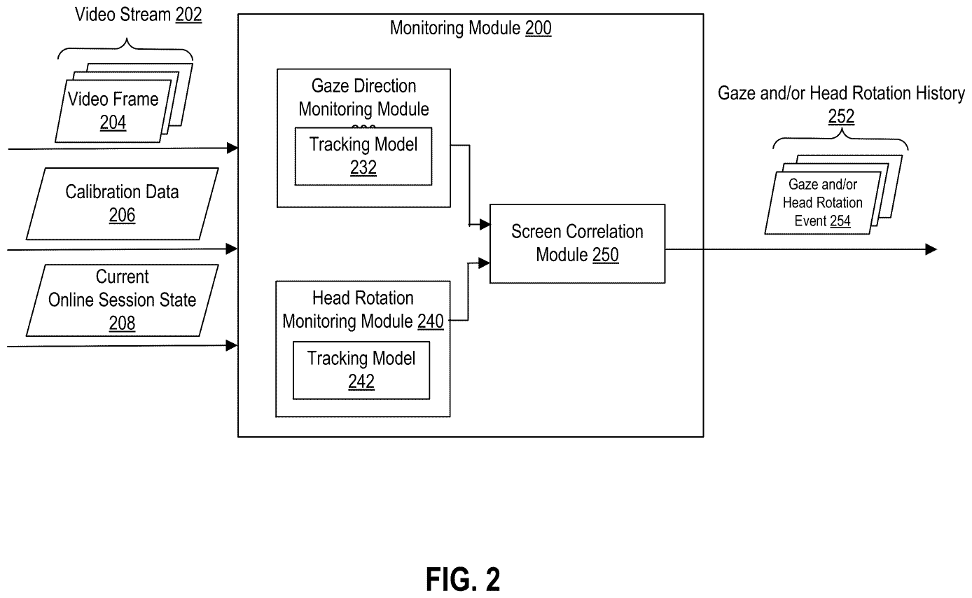

FIG. 2 is a block diagram of an example monitoring module 200, according to some aspects of the present disclosure. In some aspects, the monitoring module 120 in FIG. 1 is implemented as the monitoring module 200.

In some aspects, the monitoring module 120 is configured to receive at least one of the following inputs: a video data stream 202 comprising one or more video frames 204 (e.g., from camera module 114 in FIG. 1); calibration data 206 related to a user (e.g., user 108 in FIG. 1) (e.g., from calibration module 118 in FIG. 1); or a current state 208 of an online session initialized for the user (e.g., from initialization module 116 in FIG. 1). In some aspects, the current state 208 of the online session comprises current on-screen content presented to the user via a display (e.g., display 104 in FIG. 1).

In some aspects, the monitoring module 200 includes a gaze direction monitoring module 230 configured to continuously monitor an eye gaze direction of the user during the online session. Specifically, the gaze direction monitoring module 230 utilizes at least one tracking model 232 to track and estimate a current eye gaze direction of the user based on a subset of video frames 204 of the video data stream 202 that capture the user while the current on-screen content (e.g., current GUI) is presented on the display.

In some aspects, the monitoring module 200 includes a head rotation monitoring module 240 configured to continuously monitor a head rotation of the user during the online session. Specifically, the head rotation monitoring module 240 utilizes at least one tracking model 242 to track and estimate a current head rotation of the user based on a subset of video frames 204 of the video data stream 202 that capture the user while the current on-screen content (e.g., current GUI) is presented on the display.

In some aspects, each of the models 232, 242 is a machine learning model.

In some aspects, the monitoring module 200 includes a screen correlation module 250 configured to determine, based on the calibration data 206 and at least one of the current eye gaze direction (e.g., from gaze direction monitoring module 230) or the current head rotation (e.g., from head rotation monitoring module 240), a corresponding screen position/region on the display the user is currently looking directly at.

In some aspects, the screen correlation module 250 is configured to provide, as output, a sequence of time-stamped events 254 relating to the user. The time-stamped events 254 represent a history 252 of one or more eye gazes and/or one or more head rotations of the user during the online session. Each time-stamped event 254 corresponds to a particular time during the online session, and the time-stamped event 254 includes event information identifying: (1) at least one of an estimated eye gaze direction or an estimated head rotation of the user at that particular time, and (2) a corresponding screen position/region on the display the user is looking directly at, at that particular time.

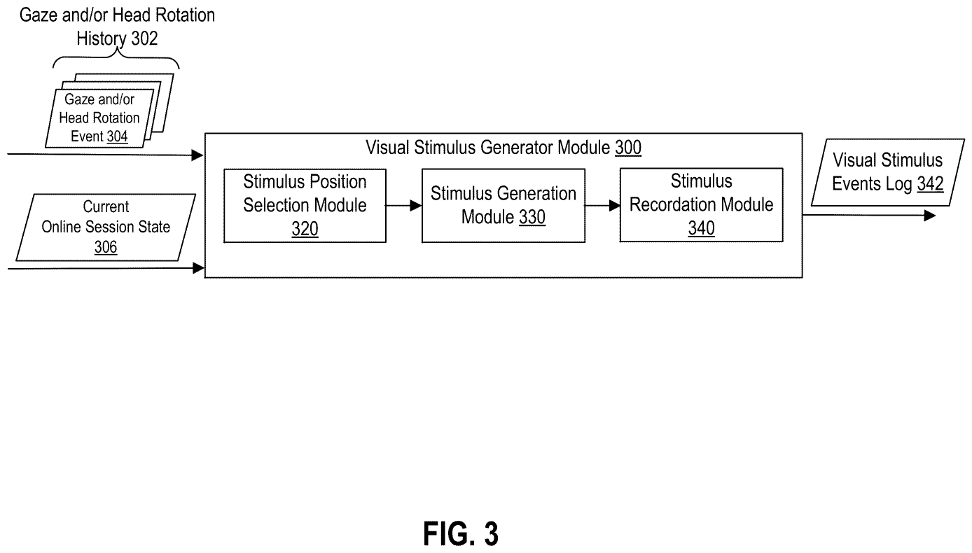

FIG. 3 is a block diagram of an example visual stimulus generator module 300, according to some aspects of the present disclosure. In some aspects, the visual stimulus generator module 122 in FIG. 1 is implemented as the visual stimulus generator module 300.

In some aspects, the visual stimulus generator module 300 is configured to receive at least one of the following inputs: a sequence of time-stamped events 304 relating to a user (e.g., user 108 in FIG. 1) (e.g., from monitoring module 120 in FIG. 1 or monitoring module 200 in FIG. 2); or a current state 306 of an online session initialized for the user (e.g., from initialization module 116 in FIG. 1). The time-stamped events 304 represent a history 302 of one or more eye gazes and/or one or more head rotations of the user during the online session. In some aspects, the current state 306 of the online session comprises current on-screen content presented to the user via a display (e.g., display 104 in FIG. 1).

In some aspects, the visual stimulus generator module 300 is configured to initiate, at a random time or when a suspicious condition is met (e.g., trust/suspicion score falls below a predefined threshold), a verification check during the online session. In some aspects, the visual stimulus generator module 122 includes a stimulus position selection module 320 configured to randomly select a screen position/region on the display. In some aspects, the visual stimulus generator module 122 includes a stimulus generation module 330 configured to generate a visual stimulus element. As part of the verification check, the visual stimulus element is presented on the display (e.g., via display module 112 in FIG. 1) at the screen position/region randomly selected and for a short pre-defined period of time. In some aspects, multiple visual stimulus elements are generated and presented during the verification check, one after another.

In some aspects, the visual stimulus generator module 122 includes a stimulus recordation module 340 configured to record, for each visual stimulus element presented, a corresponding start time representing when the visual stimulus element is first presented, a corresponding end time representing when the visual stimulus element is last presented, and a corresponding screen position/region on the display the visual stimulus element is positioned at.

In some aspects, the stimulus recordation module 340 is configured to provide, as output, a visual stimulus events log 342 relating to the user. The visual stimulus events log 342 comprises event information relating to one or more visual stimulus elements presented to the user during the verification check, such as, but not limited to, one or more start times, one or more end times, and/or one or more screen positions/regions corresponding to the one or more visual stimulus elements.

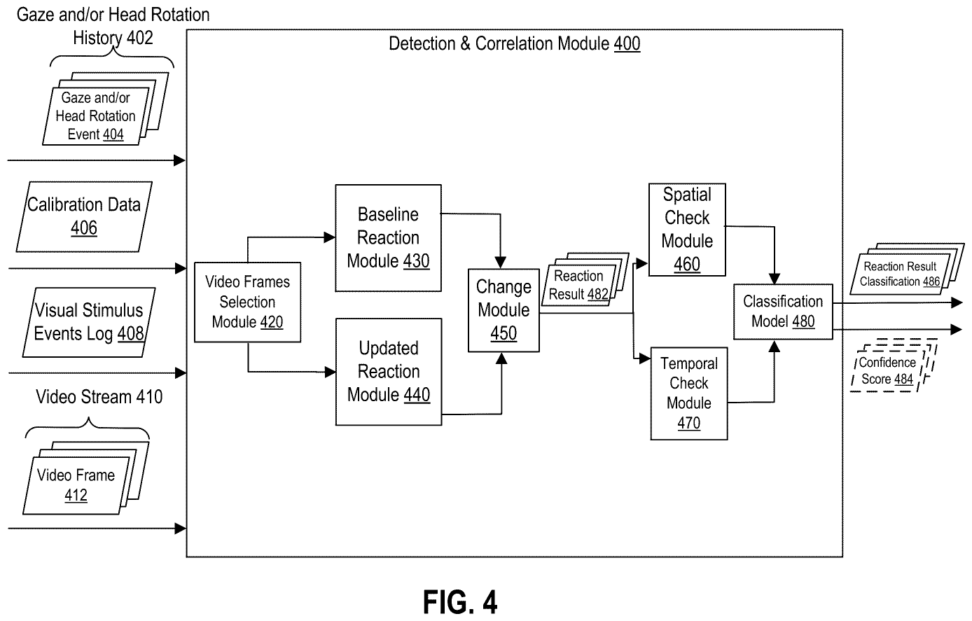

FIG. 4 is a block diagram of an example detection and correlation module 400, according to some aspects of the present disclosure. In some aspects, the detection and correlation module 124 in FIG. 1 is implemented as the detection and correlation module 400.

In some aspects, the detection and correlation module 400 is configured to receive at least one of the following inputs: a sequence of time-stamped events 404 relating to a user (e.g., user 108 in FIG. 1) (e.g., from monitoring module 120 in FIG. 1 or monitoring module 200 in FIG. 2) ; calibration data 406 relating to the user (e.g., from calibration module 118 in FIG. 1); a visual stimulus events log 408 relating to the user (e.g., from visual stimulus generator module 122 in FIG. 1 or visual stimulus generator module 300 in FIG. 3); or a video data stream 410 comprising one or more video frames 412 (e.g., from camera module 114 in FIG. 1). The time-stamped events 404 represent a history 402 of one or more eye gazes and/or one or more head rotations of the user during the online session.

In some aspects, the detection and correlation module 400 is configured to detect at least one change in at least one of an eye gaze direction or a head rotation of the user during a verification check, based on at least one of the inputs received. In some aspects, the detection and correlation module 400 includes a video frames selection module 420. For each visual stimulus element presented to the user via a display (e.g., display 104 in FIG. 1) during the verification check (as determined from the visual stimulus events log 408), the video frames selection module 420 is configured to select one or more video frames 412 of the video data stream 410 that occur within a reaction time window occurring after a start time corresponding to the visual stimulus element.

In some aspects, the detection and correlation module 400 includes a baseline reaction module 430. For one or more video frames 412 of the video data stream 410 that immediately precede a start time corresponding to a visual stimulus element presented during the verification check, the baseline reaction module 430 determines at least one of a baseline eye gaze direction or a baseline head rotation of the user before the visual stimulus element is presented, and a baseline screen position/region on the display corresponding to the baseline eye direction and/or the baseline head rotation.

In some aspects, the detection and correlation module 400 includes an updated reaction module 440. For one or more selected video frames (e.g., selected via video frames selection module 420) within a reaction time window corresponding to a visual stimulus element presented, the updated reaction module 440 determines at least one of an updated eye gaze direction or an updated head rotation of the user during the corresponding reaction time window, and an updated screen position/region on the display corresponding to the updated eye gaze direction and/or the updated head rotation.

In some aspects, the detection and correlation module 400 includes a change module 450. For each visual stimulus element presented, the change module 450 computes a corresponding reaction result 482. A reaction result 482 corresponding to a visual stimulus element presented comprises at least one of the following changes: (1) a change between a baseline eye gaze direction of the user before the visual stimulus element is presented and an updated eye gaze direction during a corresponding reaction time window (i.e., eye gaze direction change), or (2) a change between a baseline head rotation of the user before the visual stimulus element is presented and an updated head rotation during the corresponding reaction time window (i.e., head rotation change).

In some aspects, the detection and correlation module 400 includes a spatial check module 460 configured to determine, for each visual stimulus element presented, whether a spatial condition is met based on a reaction result 482 corresponding to the visual stimulus element. Specifically, the spatial check module 460 checks if an updated screen position/region on the display substantially matches a screen position/region corresponding to the visual stimulus element within a pre-defined spatial threshold, where the updated screen position/region corresponds to an updated eye gaze direction and/or an updated head rotation during a corresponding reaction time window. The spatial condition is met if the updated screen position/region substantially matches the screen position/region corresponding to the visual stimulus element within the pre-defined spatial threshold, i.e., there is spatial correspondence.

In some aspects, the detection and correlation module 400 includes a temporal check module 470 configured to determine, for each visual stimulus element presented, whether a temporal condition is met based on a reaction result corresponding to the visual stimulus element. Specifically, the temporal check module 470 checks if the corresponding reaction result (i.e., eye gaze direction change and/or head rotation change) occurs within a pre-defined temporal threshold. The temporal condition is met if the corresponding reaction result occurs within the pre-defined temporal threshold, i.e., there is temporal alignment.

In some aspects, the detection and correlation module 400 includes a classification model 480. The classification model 480 is a machine learning model configured to classify, for each visual stimulus element presented, a corresponding reaction result with a classification 486 indicative of whether the reaction result is a valid reaction (i.e., a pass/success classification) or a failure to react (i.e., a fail classification). Specifically, the corresponding reaction result is classified with a success classification if both the spatial condition and the temporal condition are met. The corresponding reaction result is classified with a fail classification instead if at least one the spatial condition or the temporal condition is not met.

In some aspects, for each visual stimulus element presented, the classification model 480 outputs a classification 486 for a corresponding reaction result and, optionally, a confidence score 484 for the classification 486.

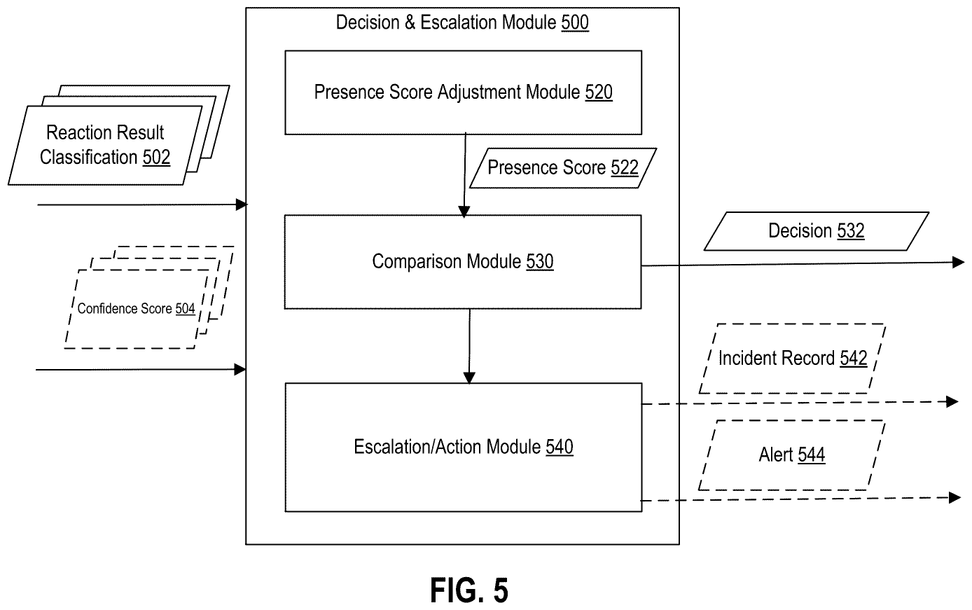

FIG. 5 is a block diagram of an example decision and escalation module 500, according to some aspects of the present disclosure. In some aspects, the decision and escalation module 126 in FIG. 1 is implemented as the decision and escalation module 500.

In some aspects, the decision and escalation module 500 is configured to receive at least one of the following inputs: one or more classifications 502 for one or more reaction results corresponding to one or more visual stimulus elements presented to a user (e.g., user 108 in FIG. 1) during a verification check during an online session (e.g., from detection and correlation module 124 in FIG. 1 or detection and correlation module 500 in FIG. 5); or, optionally, one or more confidence scores 504 for the one or more classifications 502 (e.g., from detection and correlation module 124 in FIG. 1 or detection and correlation module 500 in FIG. 5).

In some aspects, the decision and escalation module 500 is configured to maintain a presence score 522 corresponding to the user, where the presence score 522 indicates of a degree of likelihood the user is in front of a display (e.g., display 104 in FIG. 1) during the online session.

In some aspects, the decision and escalation module 500 includes a presence score adjustment module 520 configured to increase a presence score 522 corresponding to the user if classifications 502 for reaction results corresponding to a pre-defined number of consecutive visual stimulus elements presented to the user are pass/success classifications.

In some aspects, the presence score adjustment module 520 is configured to decrease a presence score 522 corresponding to the user and/or flag the online session with the user as potentially suspicious if a classification 502 for a reaction result corresponding to a visual stimulus element presented to the user is a fail classification.

In some aspects, the decision and escalation module 500 includes a comparison module 530 and an escalation/action module 540. The comparison module 530 is configured to compare a presence score 522 corresponding to the user against one or more pre-defined thresholds. In some aspects, if the presence score 522 exceeds a first pre-defined threshold, the comparison module 530 determines that the user successfully completed the verification check, and continues the online session (e.g., resumes presentation of on-screen content on the display, such as examination content).

In some aspects, if the presence score 522 falls below the first pre-defined threshold, the comparison module 530 invokes the escalation/action module 540 to perform at least one of the following actions: trigger one or more additional verification checks (e.g., by invoking visual stimulus generator module 122 in FIG. 1 or visual stimulus generator module 300 in FIG. 3); or escalate to a human proctor for manual review (e.g., generate and transmit an optional alert 544 to the human proctor).

In some aspects, if the presence score 522 falls below a second pre-defined threshold, the comparison module 530 invokes the escalation/action module 540 to perform at least one of the following actions: pause, terminate, or invalidate the online session (e.g., pause, terminate, or invalidate the online examination); generate an incident record 542 for later review; or trigger one or more other online presence and liveness verification processes (e.g., reflection-based liveness checks).

In some aspects, the comparison module 530 is configured to output, based on a presence score corresponding to the user, a decision 532 indicative of whether the user is in front of, and attending to the display during the online session.

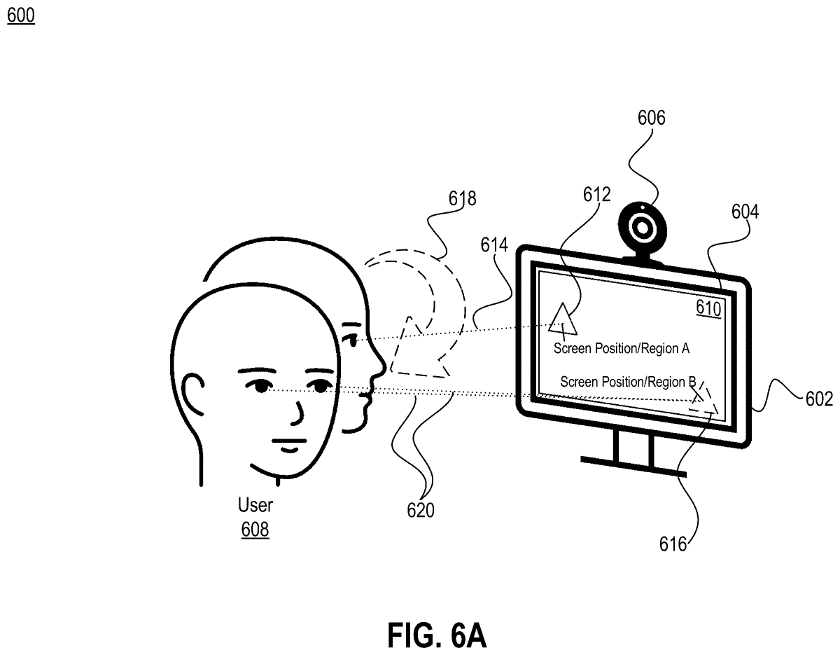

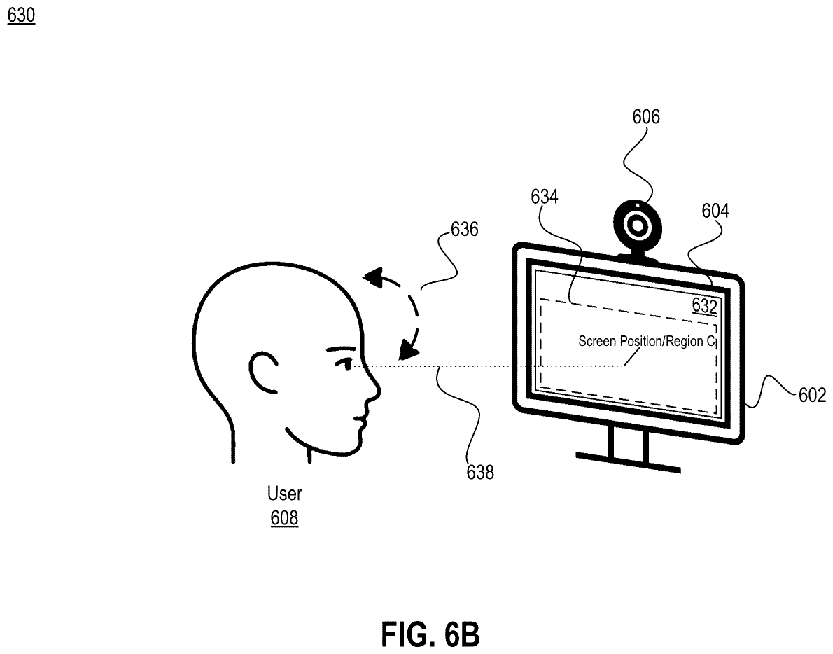

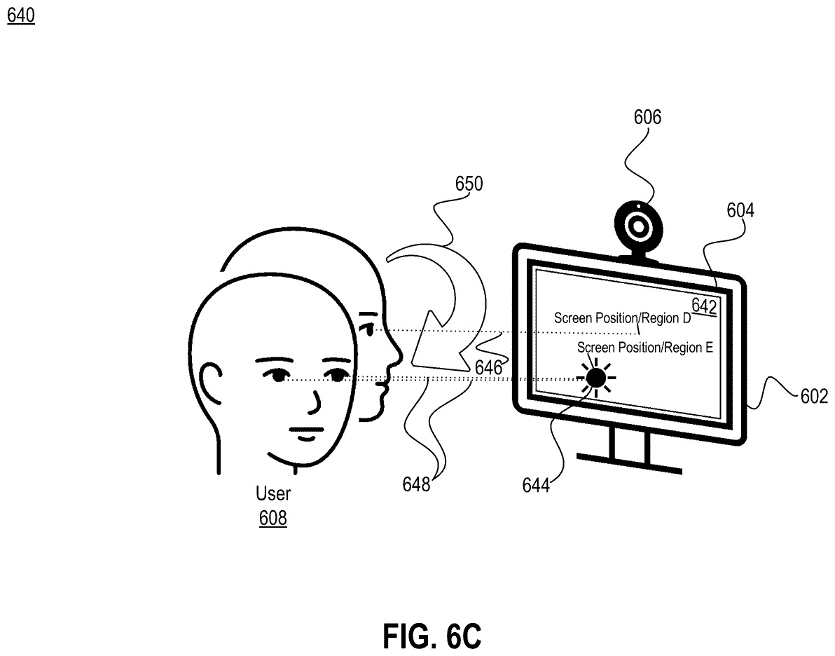

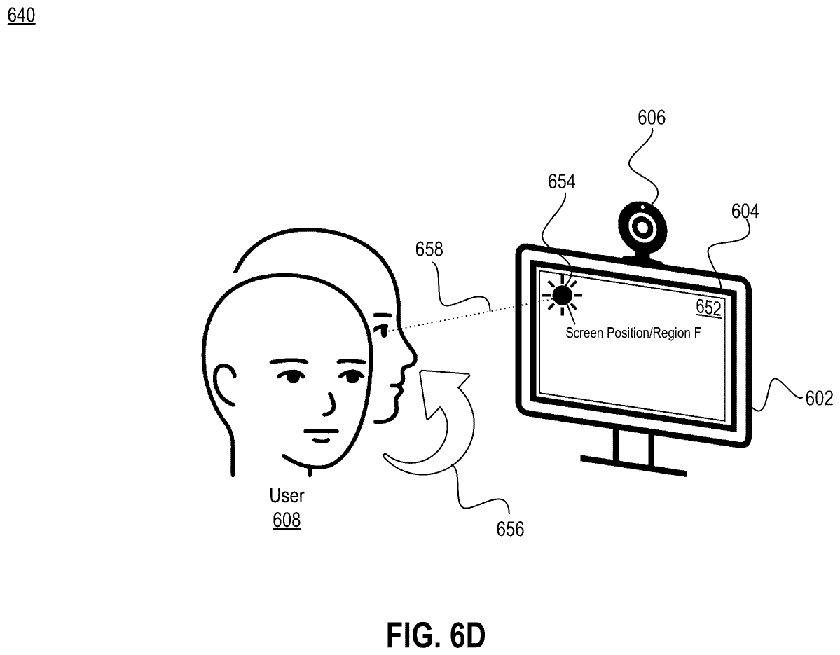

FIG. 6A is an example calibration 600 during an online session, according to some aspects of the present disclosure. In some aspects, the calibration module 118 (FIG. 1) performs a calibration process (e.g., at the start of the online session). The calibration process includes calibrating at least one of an eye gaze direction or a head rotation (i.e., head orientation) of a user 608 (e.g., user 108 in FIG. 1) in front of a display 604 (e.g., display 104 in FIG. 1) coupled to, or integrated in, a computing device 602.

In some aspects, as part of the calibration process, the calibration module 118 initiates the calibration 600 by invoking the display module 112 (FIG. 1) to present a GUI 610 including one or more calibration elements on the display 604. For example, as shown in FIG. 6A, a first calibration element 612 is first presented to the user 608 during the calibration 600. As part of the calibration process, the calibration module 118 utilizes at least one machine learning model 130 (FIG. 1) to estimate a first eye gaze direction 614 (e.g., eye gaze direction vector) and/or a first head rotation (e.g., head rotation vector) of the user 608, based on a first subset of video frames of a video data stream (e.g., from camera module 114) that capture the user 608 looking directly at the first calibration element 612. In some aspects, the video data stream is captured via a camera 606 coupled to, or integrated in, the computing device 602. The calibration module 118 computes a first mapping between a known screen position/region A on the display 604 that the first calibration element 612 is positioned at and the first eye gaze direction 614 and/or the first head rotation.

As further shown in FIG. 6A, a second calibration element 616 is next presented to the user 608 during the calibration 600 (i.e., after the first calibration element 612). As part of the calibration process, the calibration module 118 utilizes at least one machine learning model 130 (FIG. 1) to estimate a second eye gaze direction 620 (e.g., eye gaze direction vector) and/or a second head rotation 618 (e.g., head rotation vector) of the user 608, based on a second subset of video frames of the video data stream that capture the user 608 looking directly at the second calibration element 616. The calibration module 118 computes a second mapping between a known screen position/region B on the display 604 that the second calibration element 616 is positioned at and the second eye gaze direction 620 and/or the second head rotation 618.

In some aspects, the calibration module 118 provides calibration data relating to the user 608, where the calibration data includes the first mapping and the second mapping.

FIG. 6B is an example current state 630 of the same online session of FIG. 6A after the calibration 600, according to some aspects of the present disclosure. In some aspects, the current state 630 of the online session comprises current on-screen content 632 presented on the display 604, such as a current GUI (e.g., a current online examination interface if the online session comprises an online examination).

In some aspects, after the calibration 600 (FIG. 6A), the monitoring module 120 (FIG. 1) or 200 (FIG. 2) continuously monitors at least one of an eye gaze direction or a head rotation of the user 608 during the online session. In some aspects, the monitoring module 120 or 200 utilizes at least one machine learning model 130 (FIG. 1) to estimate at least one of a current eye gaze direction 638 or a current head rotation 636 of the user 608, based on a third subset of video frames of the video data stream that capture the user 608 looking directly at the current on-screen content 632. The monitoring module 120 or 200 determines, based on calibration data relating to the user 608 (e.g., from calibration module 118 in FIG. 1) and at least one of the current eye gaze direction 638 or the current head rotation 636, a screen position/region C on the display 604 that the user 608 is currently looking directly at.

In some aspects, the monitoring module 120 or 200 optionally checks that the current eye gaze direction remains within a pre-defined screen area 634 of the display 604, i.e., the current eye gaze direction is not persistently to a side of the display 604.

FIG. 6C is an example visual stimulus element 644 presented during the same online session of FIG. 6A, according to some aspects of the present disclosure. In some aspects, after the calibration 600 (FIG. 1), the visual stimulus generator module 122 (FIG. 1) or 300 (FIG. 3) initiates, at a random time or when a suspicious condition is met (e.g., trust/suspicion score falls below a pre-defined threshold), a verification check 640 during the online session. As part of the verification check 640, the visual stimulus generator module 122 or 300 is configured to: (1) randomly select a first screen position/region on the display 604 for the visual stimulus element 644, (2) generate the visual stimulus element 644 (e.g., a flashing visual object), and (3) invoke the display module 112 to present, for a short pre-defined period of time, a GUI 642 including the visual stimulus element 644 on the display 604 at the first screen position/region randomly selected for the visual stimulus element 644.

In some aspects, based on a fourth subset of video frames of the video data stream that capture the user 608 immediately before the visual stimulus element 644 is presented (e.g., before a start time corresponding to the visual stimulus element 644), the detection and correlation module 124 (FIG. 1) or 400 (FIG. 4) determines: (1) a baseline eye gaze direction 646 and/or a baseline head rotation of the user 608 before the visual stimulus element 644 is presented, and (2) a screen position/region D on the display 604 corresponding to the baseline eye direction 646 and/or the baseline head rotation.

In some aspects, based on a fifth subset of video frames of the video data stream that capture the user 608 during a reaction time window corresponding to the visual stimulus element 644, the detection and correlation module 124 (FIG. 1) or 400 (FIG. 4) determines: (1) an updated eye gaze direction 648 (i.e., eye gaze direction change) and/or an updated head rotation 650 (i.e., head rotation change) during the corresponding reaction time window, and (2) a screen position/region E on the display 604 corresponding to the updated eye gaze direction 648 and/or the updated head rotation 650.

In some aspects, the detection and correlation module 124 (FIG. 1) or 400 (FIG. 4) determines whether a spatial condition is met by checking if the screen position/region E on the display 604 corresponding to the updated eye gaze direction 648 and/or the updated head rotation 650 substantially matches the first screen position/region randomly selected for the visual stimulus element 644 within a pre-defined spatial threshold. In some aspects, the detection and correlation module 124 (FIG. 1) or 400 (FIG. 4) determines whether a temporal condition is met by checking if the updated eye gaze direction 648 and/or the updated head rotation 650 occurs within a predefined temporal threshold.

FIG. 6D is another example visual stimulus element 654 presented during the same online session of FIG. 6A, according to some aspects of the present disclosure. In some aspects, multiple visual stimulus elements 644 (FIGS. 6C) and 654 are generated and presented during the verification check 640, one after another. For example, as part of the verification check 640, the visual stimulus generator module 122 or 300 is configured to: (1) randomly select a second screen position/region on the display 604 for the visual stimulus element 654, (2) generate the visual stimulus element 654 (e.g., a flashing visual object), and (3) invoke the display module 112 to present, for a short pre-defined period of time, a GUI 652 including the visual stimulus element 654 on the display 604 at the second screen position/region randomly selected for the visual stimulus element 654.

In some aspects, based on a sixth subset of video frames of the video data stream that capture the user 608 immediately before the visual stimulus element 654 is presented, the detection and correlation module 124 (FIG. 1) or 400 (FIG. 4) determines: (1) a baseline eye gaze direction and/or a baseline head rotation of the user 608 before the visual stimulus element 654 is presented (e.g., the updated eye gaze direction 648 and/or the updated head rotation 650 in FIG. 6C if the visual stimulus element 654 is presented immediately after the visual stimulus element 644 is presented), and (2) a screen position/region on the display 604 corresponding to the baseline eye direction and/or the baseline head rotation (e.g., screen position/region E in FIG. 6C if the visual stimulus element 654 is presented immediately after the visual stimulus element 644 is presented).

In some aspects, based on a seventh subset of video frames of the video data stream that capture the user 608 during a reaction time window corresponding to the visual stimulus element 654, the detection and correlation module 124 (FIG. 1) or 400 (FIG. 4) determines: (1) an updated eye gaze direction 658 (i.e., eye gaze direction change) and/or an updated head rotation 656 (i.e., head rotation change) during the corresponding reaction time window, and (2) a screen position/region F on the display 604 corresponding to the updated eye gaze direction 658 and/or the updated head rotation 656.

In some aspects, the detection and correlation module 124 (FIG. 1) or 400 (FIG. 4) determines whether a spatial condition is met by checking if the screen position/region F on the display 604 corresponding to the updated eye gaze direction 658 and/or the updated head rotation 656 substantially matches the second screen position/region randomly selected for the visual stimulus element 654 within the pre-defined spatial threshold. In some aspects, the detection and correlation module 124 (FIG. 1) or 400 (FIG. 4) determines whether a temporal condition is met by checking if the updated eye gaze direction 658 and/or the updated head rotation 656 occurs within the pre-defined temporal threshold.

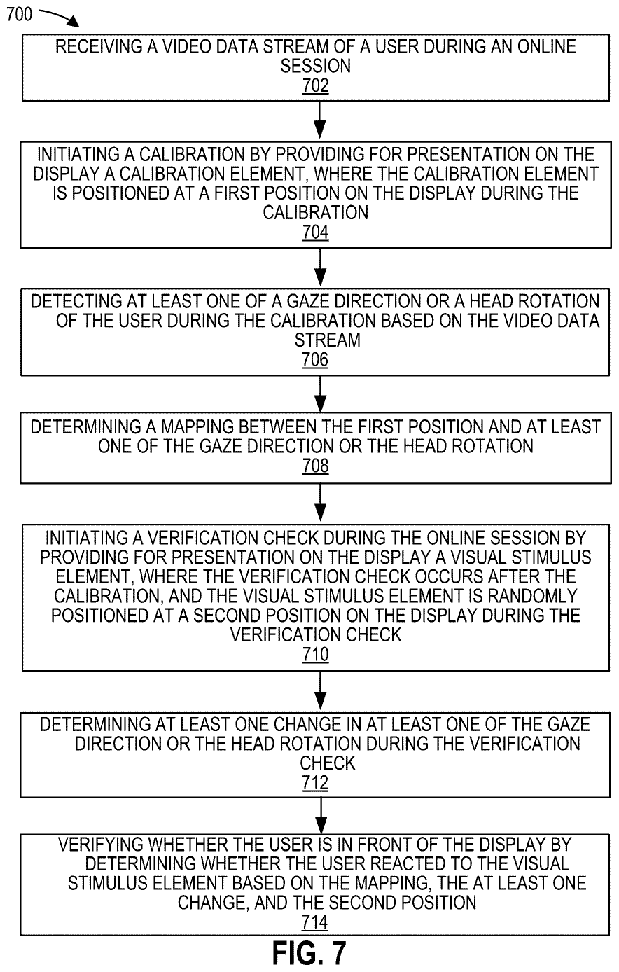

FIG. 7 is flow diagram of an example method 700 for verifying live user presence in front of a display in an online session, according to some aspects of the present disclosure. At block 702, the method 700 includes receiving a video data stream of a user during the online session.

At block 704, the method 700 includes initiating a calibration by providing for presentation on the display a calibration element, where the calibration element is positioned at a first position on the display during the calibration.

At block 706, the method 700 includes detecting at least one of a gaze direction or a head rotation of the user during the calibration based on the video data stream.

At block 708, the method 700 includes determining a mapping between the first position and at least one of the gaze direction or the head rotation.

At block 710, the method 700 includes initiating a verification check during the online session by providing for presentation on the display a visual stimulus element, where the verification check occurs after the calibration, and the visual stimulus element is randomly positioned at a second position on the display during the verification check.

At block 712, the method 700 includes determining at least one change in at least one of the gaze direction or the head rotation during the verification check.

At block 714, the method 700 includes verifying whether the user is in front of the display by determining whether the user reacted to the visual stimulus element based on the mapping, the at least one change, and the second position.

In some aspects, blocks 702-714 of the method 700 can be performed by one or more components of the user presence verification system 110 (FIG. 1), the gaze monitoring module 200 (FIG. 2), the visual stimulus generation module 300 (FIG. 3), the gaze reaction detection and correlation module 400 (FIG. 4), and/or the decision and escalation module 500 (FIG. 5).

Aspects of the present disclosures, such as the user presence verification system 110 (FIG. 1), the gaze monitoring module 200 (FIG. 2), the visual stimulus generation module 300 (FIG. 3), the gaze reaction detection and correlation module 400 (FIG. 4), and/or the decision and escalation module 500 (FIG. 5), can be implemented using hardware, software, or a combination thereof and can be implemented in one or more computer systems or other processing systems. In an aspect of the present disclosures, features are directed toward one or more computer systems capable of carrying out the functionality described herein. An example of such a computer system 20 is shown in FIG. 8. The user presence verification system 110, the gaze monitoring module 200, the visual stimulus generation module 300, the gaze reaction detection and correlation module 400, and/or the decision and escalation module 500 can include some or all of the components of the computer system 20.

FIG. 8 is a block diagram illustrating the computer system 20 on which aspects of systems and methods for AI-driven visual cues (e.g., markers, pointers, highlights, etc.) for contextual navigation within graphical user interfaces may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for verifying live user presence in front of a display in an online session, comprising:
receiving a video data stream of a user during the online session;
initiating a calibration by providing for presentation on the display a calibration element, wherein the calibration element is positioned at a first position on the display during the calibration;
detecting at least one of a gaze direction or a head rotation of the user during the calibration based on the video data stream;
determining a mapping between the first position and at least one of the gaze direction or the head rotation;
initiating a verification check during the online session by providing for presentation on the display a visual stimulus element, wherein the verification check occurs after the calibration, and the visual stimulus element is randomly positioned at a second position on the display during the verification check;
determining at least one change in at least one of the gaze direction or the head rotation during the verification check; and
verifying whether the user is in front of the display by determining whether the user reacted to the visual stimulus element based on the mapping, the at least one change, and the second position.

2. The method of claim 1, wherein the determining whether the user reacted to the visual stimulus event comprises:
determining a third position on the display corresponding to the at least one change based on the mapping.

3. The method of claim 2, wherein the determining whether the user reacted to the visual stimulus event further comprises:
making a first determination of whether there is spatial correspondence between the second position and the third position based on a spatial threshold; and
making a second determination of whether there is temporal alignment between the visual stimulus element and the at least one change based on a temporal threshold.

4. The method of claim 3, wherein the determining whether the user reacted to the visual stimulus event further comprises:
classifying, using a machine learning model, whether the user reacted to the visual event or failed to react to the visual event based on the first and second determinations.

5. The method of claim 4, wherein the determining whether the user reacted to the visual stimulus event further comprises:
determining a presence score of the user based on the classifying, wherein the presence score is indicative of a likelihood the user is in front of the display, and the user is verified to be in front of the display if the presence score exceeds a score threshold.

6. The method of claim 1, wherein the video data stream is captured via a camera of a computing device including the display.

7. The method of claim 1, wherein the online session comprises an online examination session, and the user is an examinee.

8. The method of claim 7, further comprising:
providing examination content for presentation on the display during the online examination session.

9. The method of claim 7, further comprising:
triggering at least one action in response to determining the user did not react to the visual stimulus element, wherein the at least one action comprises at least one of pausing the online examination session, terminating the online examination session, transmitting an alert to a proctor, initiating an additional verification check, or recording that the user did not react to the visual stimulus element.

10. The method of claim 1, wherein the initiating the calibration further comprises:
instructing the user to look at and activate the calibration element at the first position on the display.

11. The method of claim 1, wherein the initiating the verification check further comprises:
randomly selecting a time for the verification check, wherein the visual stimulus element is presented on the display at the randomly selected time.

12. The method of claim 1, wherein the visual stimulus element comprises at least one of a bright visual object, a colored visual object, a flashing visual object, or a popup message or image.

13. The method of claim 1, wherein the determining the at least one change in the at least one
of the gaze direction or the head rotation during the verification check comprises:
determining, using at least one machine learning model, at least one of a baseline gaze direction or a baseline head rotation of the user based on one or more video frames of the video stream that were captured immediately before the verification check; and
determining, using the at least one machine learning model, at least one of an updated gaze direction or an updated head rotation of the user based on one or more additional video frames of the video stream that were captured during the verification check.

14. A system for verifying live user presence in front of a display in an online session, comprising:
one or more memories configured to store executable instructions; and
one or more processors communicatively coupled with the one or more memories and configured, individually or in any combination, to execute the executable instructions to:
receive a video data stream of a user during the online session;
initiate a calibration by providing for presentation on the display a calibration element, wherein the calibration element is positioned at a first position on the display during the calibration;
detect at least one of a gaze direction or a head rotation of the user during the calibration based on the video data stream;
determine a mapping between the first position and at least one of the gaze direction or the head rotation;
initiate a verification check during the online session by providing for presentation on the display a visual stimulus element, wherein the verification check occurs after the calibration, and the visual stimulus element is randomly positioned at a second position on the display during the verification check;
determine at least one change in at least one of the gaze direction or the head rotation during the verification check; and
verify whether the user is in front of the display by determining whether the user reacted to the visual stimulus element based on the mapping, the at least one change, and the second position.

15. The system of claim 14, wherein the determining whether the user reacted to the visual stimulus event comprises:
determining a third position on the display corresponding to the at least one change based on the mapping.

16. The system of claim 15, wherein the determining whether the user reacted to the visual stimulus event further comprises:
making a first determination of whether there is spatial correspondence between the second position and the third position based on a spatial threshold; and
making a second determination of whether there is temporal alignment between the visual stimulus element and the at least one change based on a temporal threshold.

17. The system of claim 16, wherein the determining whether the user reacted to the visual stimulus event further comprises:
classifying, using a machine learning model, whether the user reacted to the visual event or failed to react to the visual event based on the first and second determinations.

18. The system of claim 17, wherein the determining whether the user reacted to the visual stimulus event further comprises:
determining a presence score of the user based on the classifying, wherein the presence score is indicative of a likelihood the user is in front of the display, and the user is verified to be in front of the display if the presence score exceeds a score threshold.

19. The system of claim 14, wherein the video data stream is captured via a camera of a computing device including the display.

20. A non-transitory computer-readable medium having instructions for verifying live user presence in front of a display in an online session, the instructions are executable by one or more processors, individually or in any combination, to:
receive a video data stream of a user during the online session;
initiate a calibration by providing for presentation on the display a calibration element, wherein the calibration element is positioned at a first position on the display during the calibration;
detect at least one of a gaze direction or a head rotation of the user during the calibration based on the video data stream;
determine a mapping between the first position and at least one of the gaze direction or the head rotation;
initiate a verification check during the online session by providing for presentation on the display a visual stimulus element, wherein the verification check occurs after the calibration, and the visual stimulus element is randomly positioned at a second position on the display during the verification check;
determine at least one change in at least one of the gaze direction or the head rotation during the verification check; and
verify whether the user is in front of the display by determining whether the user reacted to the visual stimulus element based on the mapping, the at least one change, and the second position.
